(19) United States
(12) Patent Application Publication
(10) Pub. No.: US 2025/0277954 A1
(43) Pub. Date: Sep. 4, 2025

(54) PULLING JIG, OPTICAL CABLE PULLING METHOD, AND OPTICAL CABLE PULLING SYSTEM

(71) Applicants: SUMITOMO ELECTRIC INDUSTRIES, LTD., Osaka (JP); SUMITOMO ELECTRIC OPTIFRONTIER CO., LTD., Kanagawa (JP)

(72) Inventors: Takayuki SHIMAZU, Osaka (JP); Junji FUKUI, Kanagawa (JP); Masahiro SHIBATA, Kanagawa (JP)

(21) Appl. No.: 19/069,592

(22) Filed: Mar. 4, 2025

(30) Foreign Application Priority Data
Mar. 4, 2024 (JP) 2024-032397

(51) Int. Cl. G02B 6/54

(52) U.S. Cl. CPC G02B 6/54

(57) ABSTRACT

A pulling jig for pulling a plurality of optical cables while maintaining a state in which the optical cables are arranged in parallel, the pulling jig includes a base portion having a width equal to or more than a width in the state in which the plurality of optical cables are arranged in parallel, a pulling portion for enabling the base portion to be connected to a pulling device, and a plurality of connecting portions provided at the base portion and arranged in a width direction along the width. The connecting portions are connectable to the optical cables in at least one-to-one correspondence.

### TECHNICAL FIELD

The present disclosure relates to a pulling jig, an optical cable pulling method, and an optical cable pulling system. This application claims priority based on Japanese Patent Application No. 2024-032397 filed on Mar. 4, 2024, and the entire contents of the Japanese patent application are incorporated herein by reference.

### BACKGROUND

Japanese Unexamined Patent Application Publication No. 2023-083096 discloses that a server rack group including a plurality of server racks and a distributing frame are connected by an optical cable.

### SUMMARY

A pulling jig according to an aspect of the present disclosure is a pulling jig for pulling a plurality of optical cables while maintaining a state in which the optical cables are arranged in parallel. The pulling jig includes a base portion having a width equal to or more than a width in the state in which the plurality of optical cables are arranged in parallel, a pulling portion for enabling the base portion to be connected to a pulling device, and a plurality of connecting portions provided at the base portion and arranged in a width direction along the width. The connecting portions are connectable to the optical cables in at least one-to-one correspondence.

### BRIEF DESCRIPTION OF THE DRAWINGS

FIG. 1 illustrates an optical communication system according to the present embodiment.

FIG. 2 is a schematic diagram of an optical branch cable.

FIG. 3 is a cross-sectional view of a main cable.

FIG. 4 is a partial enlarged view of a tape.

FIG. 5 illustrates a branch cord bag.

FIG. 6 is a cross-sectional view of the VI-VI cross section in FIG. 2.

FIG. 7 is a perspective view of a bending restriction member.

FIG. 8 illustrates a bending restriction member and a branch cord portion.

FIG. 9 illustrates an installation of an optical branch cable using a pulling jig.

FIG. 10 is a plan view of a pulling jig.

FIG. 11 is a cross-sectional view of the XI-XI plane in FIG. 10.

FIG. 12 illustrates a fixed position of a connecting portion.

FIG. 13 is a diagram of an optical branch cable as viewed of a direction intersecting a width direction.

FIG. 14 illustrates an optical branch cable aligned by a pulling jig.

FIG. 15 is a perspective view of an optical branch cable set according to a modification.

FIG. 16 illustrates an optical branch cable set and a branch cord bag according to the modification.

FIG. 17 illustrates an arrangement example of a branch cord portion of each optical branch cable.

### DETAILED DESCRIPTION

Depending on the number of server racks arranged in the server rack group, a plurality of optical cables may be installed in parallel so as to extend in the same direction. The work of installing many optical cables has been complicated.

An object of the present disclosure is to improve the installation workability when installing a plurality of optical cables.

### Description of Embodiments of Present Disclosure

First, embodiments of the present disclosure will be listed and described.

(1) A pulling jig according to an aspect of the present disclosure is a pulling jig for pulling a plurality of optical cables while maintaining a state in which the optical cables are arranged in parallel. The pulling jig includes a base portion having a width equal to or more than a width in the state in which the plurality of optical cables are arranged in parallel, a pulling portion for enabling the base portion to be connected to a pulling device, and a plurality of connecting portions provided at the base portion and arranged in a width direction along the width. The connecting portions are connectable to the optical cables in at least one-to-one correspondence.

The pulling jig includes a plurality of connecting portions arranged along the width direction, and each connecting portions is configured to be connectable to one optical cable, allowing the plurality of optical cables to be pulled with each one connected to the connecting portions. This enables the plurality of optical cables to be pulled at once with as equal force as possible, the installation workability of the optical cables are improved.

(2) In the pulling jig according to (1), each of the optical cables may include a main cable including a plurality of optical fiber core wires, and a branch cable portion in which at least one of the optical fiber core wires is led out from the main cable. The connecting portions may be fixable at any one of at least two different positions in a direction intersecting the width direction.

Depending on the optical cable, the branching portion where the main cable and the branch cable portion branch off may be formed at a position shifted from the end portion of the optical cable.

According to the pulling jig, the connecting portion is fixable in one of two different positions in a direction intersecting the width direction, even when the position of the branching portion is shifted in the longitudinal direction depending on the optical cable, the positions of the branching portions in the longitudinal direction are easily aligned to some extent by the displacements of the connecting portions.

(3) In the pulling jig according to (2), a guide portion extending in the direction intersecting the width direction may be formed at the base portion. Each of the connecting portions may be displaceable along the guide portion.

According to the pulling jig, since the connecting portion is configured to be displaced along the guide portion, a mechanism capable of changing the position of the connecting portion in the direction intersecting the width direction can be realized by a simple configuration.

(4) In the pulling jig according to (3), the guide portion may be formed as a guide slit. Each of the connecting portions may include a positioning portion and an engaging tool. The positioning portion may include a shaft portion being able to be inserted through the guide slit, an external thread being formed on at least a portion of an outer surface, and an engaging portion disposed below the guide slit, the engaging portion being not able to be inserted through the guide slit. An internal thread being able to be fastened to the shaft portion may be formed in the engaging tool. A position of the connecting portion may be fixed with respect to the base portion in the direction intersecting the width direction by the engaging tool being fastened to the shaft portion.

According to the pulling jig, the engaging tool is fastened to the shaft portion, and thus it is possible to realize a mechanism for fixing the movement and the position of the connecting portion with respect to the base portion in the direction intersecting the width direction with a simple configuration.

(5) An optical cable pulling method according to an aspect of the present disclosure includes pulling a plurality of optical cables while maintaining a state in which the optical cables are arranged in parallel using the pulling jig according to any one of (1) to (4).

According to the optical cable pulling method, since the plurality of optical cables can be pulled at the same time by using the pulling jig, the installation workability of the optical cables are improved.

(6) An optical cable pulling system according to an aspect of the present disclosure includes the pulling jig according to any one of (1) to (4), and an optical cable set including a plurality of optical cables. Each of the optical cables includes a main cable including a plurality of optical fiber core wires, and a branch cable portion in which at least one of the optical fiber core wires is branched from the main cable. The plurality of optical cables are arranged in parallel in the width direction. The connecting portions are connected to the optical cables in one-to-one correspondence.

According to the optical cable pulling system, since one optical cable is connected to each of the connecting portions, it is possible to pull a plurality of optical cables simultaneously with as equal force as possible. Thus, since the plurality of optical cables can be pulled simultaneously, the installation workability of the optical cables are improved.

### Details of Embodiments of Present Disclosure

Specific examples of a pulling jig, an optical cable pulling method, and an optical cable pulling system according to embodiments of the present disclosure will be described below with reference to the drawings. The present disclosure is not limited to these illustrations, but is defined by the appended claims, and is intended to include all modifications within the scope and meaning equivalent to the appended claims.

### Optical Branch Cable

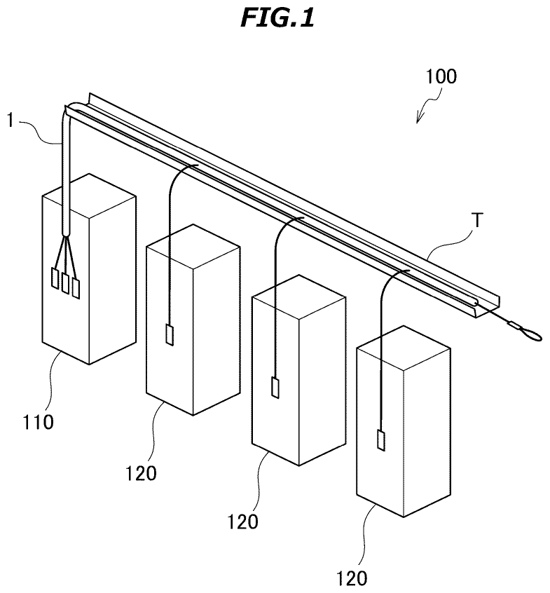

FIG. 1 illustrates an optical communication system 100 according to the present embodiment. As illustrated in FIG. 1, optical communication system 100 includes a distributing frame 110 and a plurality of server racks 120. Optical branch cables 1 used in optical communication system 100 are connected to distributing frame 110. Server rack 120 accommodates physical servers therein. An optical fiber branched from optical branch cable 1 is connected to each server rack 120. Optical branch cable 1 is installed on a cable laying tray T and wired to distributing frame 110 and server rack 120.

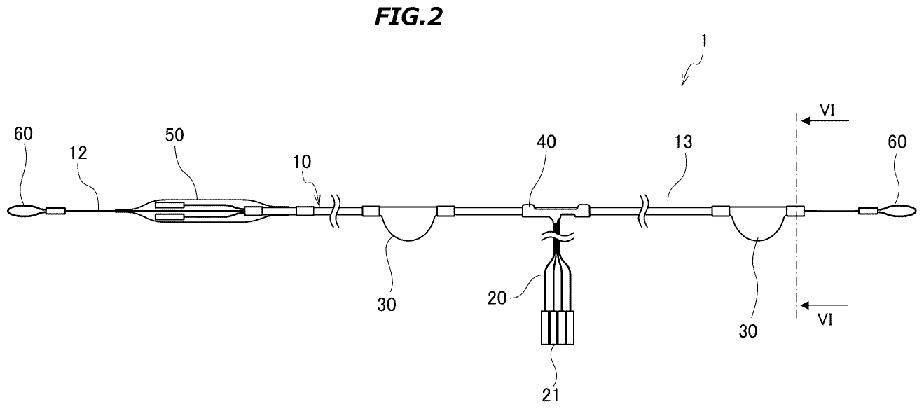

FIG. 2 is a schematic view of optical branch cable 1. As illustrated in FIG. 2, optical branch cable 1 includes a main cable 10, a branch cord portion 20, a branch cord bag 30, a bending restriction member 40, an end portion bag 50, and a connecting loop 60.

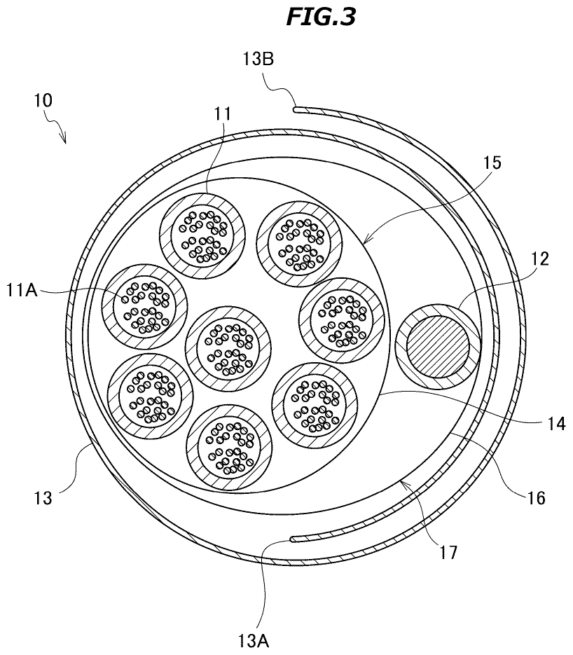

FIG. 3 is a cross-sectional view of main cable 10. Main cable 10 includes a plurality of optical cords 11, a tension member 12, and a tape 13. Optical cord 11, tension member 12, and tape 13 are arranged along the longitudinal direction of main cable 10.

Each of optical cords 11 includes at least one optical fiber core wire 11A therein. In the present embodiment, optical cord 11 includes 24 optical fiber core wires 11A therein. The plurality of optical cords 11 are bundled in a first bundle 14 to constitute an optical cord group 15.

Tension member 12 is formed of, for example, fiber reinforced plastic (FRP) such as aramid FRP, glass FRP, or carbon FRP. Tension member 12 is configured to be applied with tension when optical branch cable 1 is pulled. Optical cord group 15 and tension member 12 are bundled by a second bundle 16 to constitute a core portion 17.

Tape 13 forms the outermost layer of main cable 10. Tape 13 is configured to maintain a shape covering core portion 17 by being wound around core portion 17 by longitudinal wrapping. Tape 13 is a sheet-like insulating resin, and may be formed of, for example, polyester.

Returning to FIG. 2, branch cord portion 20 is a cord in which at least one optical fiber core wire 11A is led out from optical cord 11 of main cable 10 to the outer side of tape 13 which is the outermost layer. An optical connector 21 is provided at the end of branch cord portion 20. Branch cord portion 20 may be a portion in which optical fiber core wire 11A in optical cord 11 is led out to the outer side of the outermost layer of main cable 10, or may be a portion in which optical cord 11 itself is led out to the outer side of the outermost layer of main cable 10.

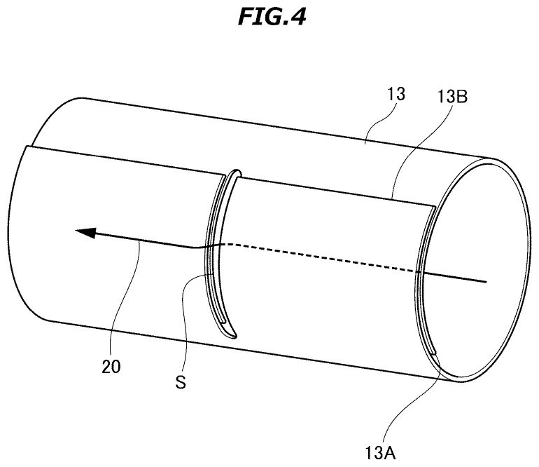

FIG. 4 is a partially enlarged view of tape 13. As illustrated in FIG. 4, tape 13 is wound around core portion 17 by longitudinal wrapping, so that an overlapping portion is formed where tape 13 overlaps in double layers. In the overlapping portion, an end portion of the inner layer portion of tape 13 in the circumferential direction is referred to as a first end portion 13A, and an end portion of the outer layer portion of tape 13 in the circumferential direction is referred to as a second end portion 13B.

Tape 13 has a slit S formed at a position corresponding to the branching portion at which branch cord portion 20 is branched from main cable 10. Slit S is formed in a portion of tape 13 in the circumferential direction so as to extend in the circumferential direction of main cable 10.

Slit S is formed to penetrate the inner layer portion and the outer layer portion of the overlapping portion. Slit S is formed from first end portion 13A to second end portion 13B in the overlapping portions of the longitudinal wrapping of tape 13. In other words, slit S is formed to include first end portion 13A and second end portion 13B.

Branch cord portion 20 is led out from main cable 10 through slit S. FIG. 4 illustrates branch cord portion 20 passing through slit S by an arrow. It is noted that, the dashed line indicates that branch cord portion 20 passes through the inner side of tape 13 which is the outermost layer of main cable 10.

As illustrated in FIG. 4, branch cord portion 20 passes through the inner side of the outermost layer formed by tape 13 before branching from main cable 10. Branch cord portion 20 is led out from main cable 10 by passing through slit S. After being branched, branch cord portion 20 is arranged to the outer side of the outermost layer.

### Branch Cord Bag

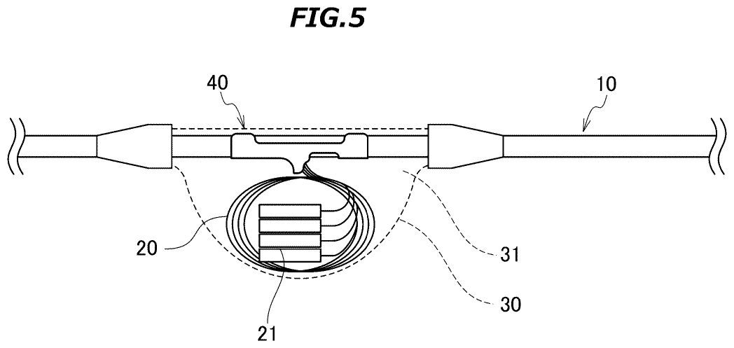

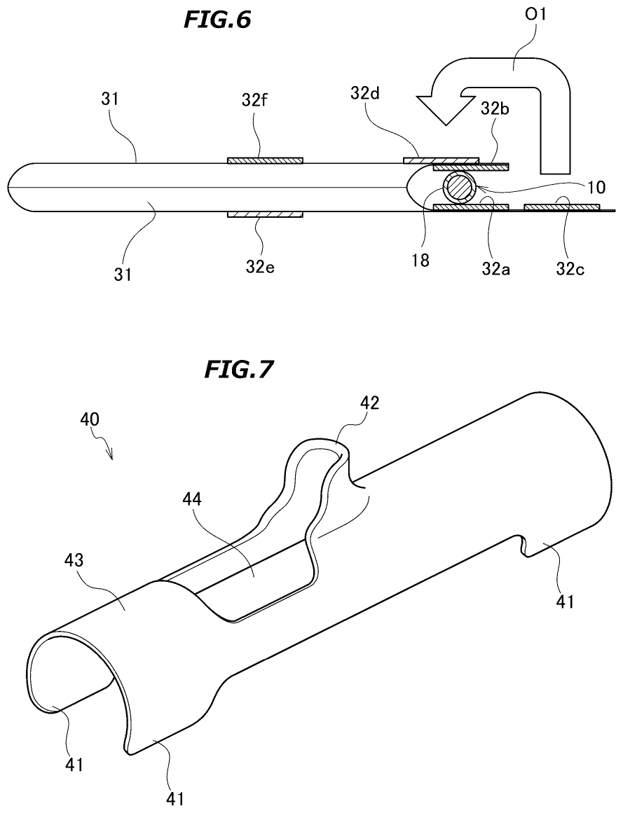

FIG. 5 illustrates branch cord bag 30. In FIG. 5, the outer shape line of branch cord bag 30 is shown by a dashed line. FIG. 6 is a cross-sectional view of the VI-VI cross section in FIG. 2.

Branch cord bag 30 is configured to be capable of housing branch cord portion 20. Branch cord portion 20 is accommodated in branch cord bag 30 when it is not necessary to connect to server rack 120 (refer to FIG. 1) during transportation or the like. Branch cord bag 30 is configured to be capable of housing branch cord portion 20 in a state where at least a portion of branch cord portion 20 is wound in a coil shape.

Branch cord bag 30 has a flat shape, with a portion of it being formed to be openable. At least one surface of branch cord bag 30 may have a semicircular shape. In the present embodiment, the outer surface of branch cord bag 30 may have two main surfaces 31. Main surface 31 is a surface having the largest area in branch cord bag 30. Main surface 31 of branch cord bag 30 may have a semicircular shape so as to follow branch cord portion 20 wound in a coil shape.

As illustrated in FIG. 6, a first hook or loop fastener portion 32a and a second hook or loop fastener portion 32b are formed on the inner surface of branch cord bag 30. First hook or loop fastener portion 32a and second hook or loop fastener portion 32b are formed at positions of main surface 31 where the opening of branch cord bag 30 is formed so that the coupling surfaces thereof face main cable 10. In the present embodiment, first hook or loop fastener portion 32a and second hook or loop fastener portion 32b form a hook surface of the hook and loop fastener.

A cable hook or loop fastener portion 18 is formed on the outer surface of main cable 10. Cable hook or loop fastener portion 18 may be provided only at a position corresponding to the branching portion. In the present embodiment, cable hook or loop fastener portion 18 forms a loop surface.

First hook or loop fastener portion 32a and second hook or loop fastener portion 32b are configured to be capable of coupling to cable hook or loop fastener portion 18. In other words, the inner surface of branch cord bag 30 and main cable 10 are coupled by first hook or loop fastener portion 32a, second hook or loop fastener portion 32b, and cable hook or loop fastener portion 18. In the present embodiment, a third hook or loop fastener portion 32c forms a hook surface of the hook and loop fastener.

As illustrated in FIG. 6, third hook or loop fastener portion 32c is formed on the inner surface of branch cord bag 30. Third hook or loop fastener portion 32c is formed to protrude in the direction of the opening of branch cord bag 30.

On the outer surface of main surface 31 where second hook or loop fastener portion 32b is provided in branch cord bag 30, a fourth hook or loop fastener portion 32d is formed. In the present embodiment, fourth hook or loop fastener portion 32d forms a loop surface.

Third hook or loop fastener portion 32c is configured to be capable of coupling to fourth hook or loop fastener portion 32d. As illustrated in FIG. 6, third hook or loop fastener portion 32c is coupled to fourth hook or loop fastener portion 32d by performing a coupling operation O1 to bend the portion provided with third hook or loop fastener portion 32c onto fourth hook or loop fastener portion 32d. This allows the opening of branch cord bag 30 to be closed. Branch cord bag 30 is arranged to be wound around main cable 10, making the coupling between branch cord bag 30 and main cable 10 stronger.

On the outer surface of main surface 31 where first hook or loop fastener portion 32a is provided in branch cord bag 30, a fifth hook or loop fastener portion 32e is formed. In the present embodiment, fifth hook or loop fastener portion 32e forms a loop surface.

On the outer surface of main surface 31 where second hook or loop fastener portion 32b is provided in branch cord bag 30, a sixth hook or loop fastener portion 32f is formed. In the present embodiment, sixth hook or loop fastener portion 32f forms a hook surface.

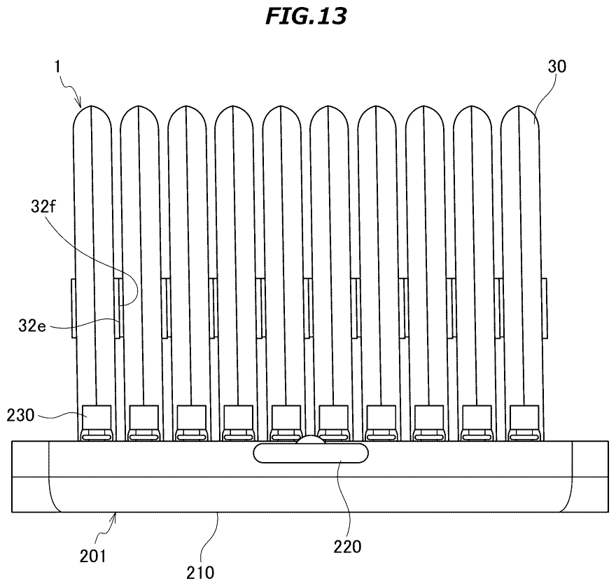

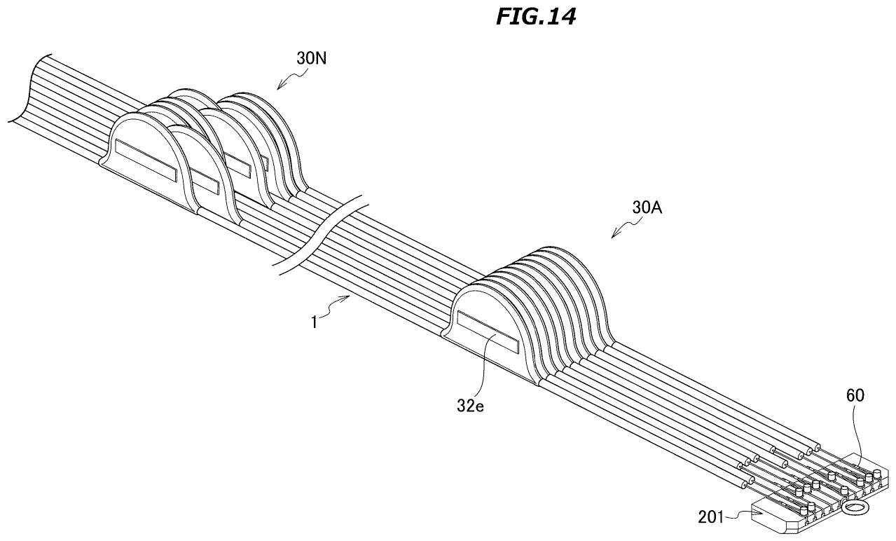

Fifth hook or loop fastener portion 32e is configured to be capable of coupling to sixth hook or loop fastener portion 32f of another branch cord bag 30 (refer to FIG. 13). Fifth hook or loop fastener portion 32e and sixth hook or loop fastener portion 32f may be formed to extend in the longitudinal direction of main cable 10 (refer to FIG. 14). Fifth hook or loop fastener portion 32e and sixth hook or loop fastener portion 32f are examples of the outer hook or loop fastener portion.

### Bending Restriction Member

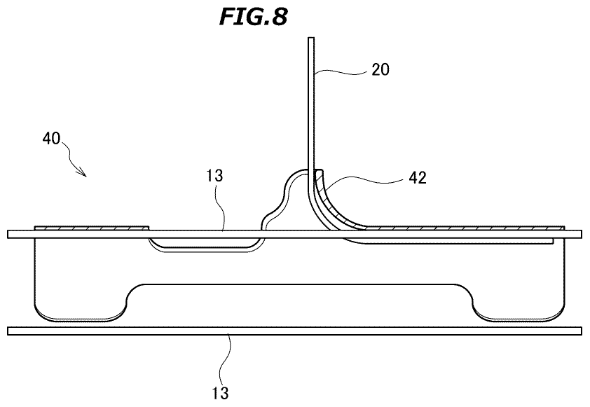

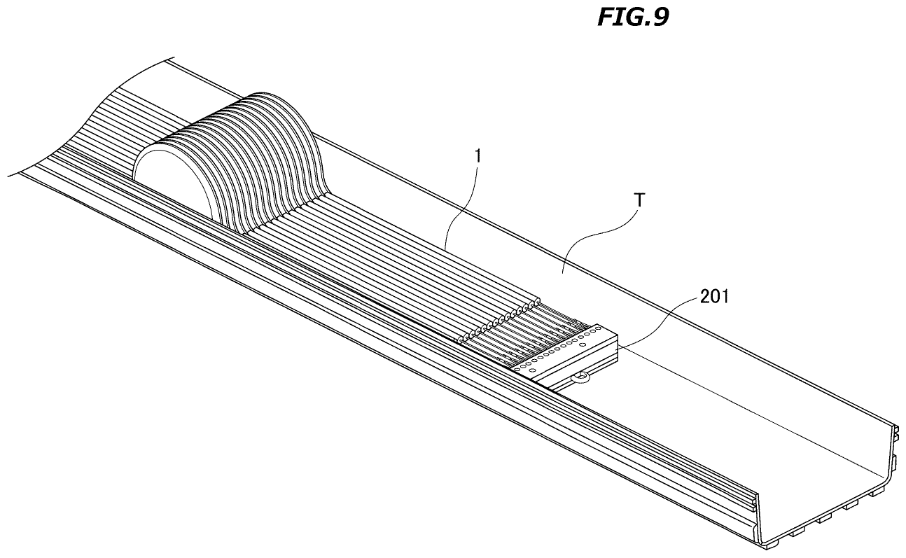

As illustrated in FIG. 2 and FIG. 5, bending restriction member 40 is attached to a position corresponding to the branching portion of optical branch cable 1. FIG. 7 is a perspective view of bending restriction member 40. FIG. 8 illustrates bending restriction member 40 and branch cord portion 20.

As illustrated in FIG. 7, bending restriction member 40 includes a mounting portion 41, a bending restriction portion 42, and a main body portion 43.

Mounting portion 41 is configured to be attachable to main cable 10. In the present embodiment, bending restriction member 40 is provided with four mounting portions 41. Bending restriction member 40 is attached to main cable 10 by sandwiching main cable 10 with four mounting portions 41.

Main body portion 43 is formed in a curved shape so as to follow the outer shape of main cable 10. Thus, main body portion 43 has a partially cylindrical shape.

Bending restriction portion 42 is provided to protrude from main body portion 43 in a direction intersecting the axial direction of main cable 10 when bending restriction member 40 is attached to main cable 10. The boundary portion between bending restriction portion 42 and main body portion 43 is formed in a curved shape having a roundness so as to have a bending radius equal to or larger than a predetermined bending radius.

Bending restriction portion 42 restricts the position of branch cord portion 20 so that branch cord portion 20 is not bent with a radius less than the predetermined bending radius. As illustrated in FIG. 8, branch cord portion 20 is led out from main cable 10 along the boundary portion between bending restriction portion 42 and main body portion 43.

Main body portion 43 defines a connector pass-through portion 44 which is a hole through which optical connector 21 is able to pass, together with bending restriction portion 42. When bending restriction member 40 is attached to main cable 10, optical connector 21 and branch cord portion 20 are passed through connector pass-through portion 44 and accommodated in branch cord bag 30 together with bending restriction member 40.

As shown in FIG. 2, end portion bag 50 is provided to protect the end portion of optical cord 11 that exposed to outside at the end of main cable 10 and an end optical connector provided at the end portion of optical cord 11.

Connecting loop 60 is connected to tension member 12 exposed at the end of main cable 10. Connecting loop 60 is a portion connected to a pulling device such as a winch. Connecting loop 60 is formed in a ring shape, and when connecting loop 60 is pulled, tension is applied to tension member 12, so that optical branch cable 1 can be displaced.

Next, a manufacturing process when branch cord portion 20 is led out from main cable 10 will be described.

In order to lead branch cord portion 20 out of main cable 10, optical cord 11 needs to be exposed to the outside. In the present embodiment, tape 13 is partially peeled off from the overlapping portion of tape 13 which is longitudinally wrapped, so that optical cord 11 is easily exposed to the outside. In particular, when tape 13 has slit S formed therein, tape 13 can be easily peeled off by using slit S.

In particular, as illustrated in FIG. 4, when slit S is formed from first end portion 13A which is the end portion of the inner layer portion in the circumferential direction to second end portion 13B which is the end portion of the outer layer portion in the circumferential direction as in the present embodiment, the work of exposing optical cord 11 to the outside is easy. Tape 13 is partially peeled off from second end portion 13B so that first end portion 13A is exposed to the outside, and when first end portion 13A is exposed to the outside, tape 13 is partially peeled off from first end portion 13A, thereby easily exposing optical cord 11 to the outside.

In the optical branch cable, if the outermost layer is formed by being covered with a resin by extrusion molding, it is necessary to remove the extrusion coating in order to lead out the branch cord portion from the main cable. At this time, it is necessary to remove the entire coating of the main cable in the circumferential direction in a portion of the cable longitudinal direction, and the time and labor required for removing the coating has been a factor of increasing the number of steps in manufacturing the optical branch cable.

In optical branch cable 1 according to the present embodiment, optical cord group 15 is bundled separately from tension member 12 by first bundle 14, making it easy to work with and distinguish optical cord group 15 from tension member 12. Thus, optical fiber core wire 11A can be branched from optical cord group 15 to perform the work of manufacturing branch cord portion 20. Tape 13 of the outermost layer covers core portion 17 by being wound by longitudinal wrapping. Thus, tape 13 can be partially peeled off from the overlapping portion of tape 13 which is longitudinally wrapped, and optical cord 11 can be exposed to the outside. Thus, optical fiber core wire 11A can be branched from main cable 10 to perform the work of manufacturing branch cord portion 20. Compared to a case where the outermost layer is formed by being coated with a resin by extrusion molding, it is not necessary to remove the extrusion coating when branch cord portion 20 is taken out, and thus it is possible to reduce the number of processes related to the manufacturing of optical branch cable 1 and to improve the ease of manufacturing optical branch cable 1.

In optical branch cable 1 according to the present embodiment, tape 13 may be partially peeled off using slit S in order to expose optical cord 11 to the outside. Thus, it is easy to perform the manufacturing work of branch cord portion 20. Further, since branch cord portion 20 branches from main cable 10 through slit S, the area where the inner portion of main cable 10 is exposed can be reduced after the manufacturing work of branch cord portion 20.

In optical branch cable 1 according to the present embodiment, since first end portion 13A which is the end portion of the inner layer portion in the circumferential direction and second end portion 13B which is the end portion of the outer layer portion in the circumferential direction are partially removed by slit S, tape 13 can be easily partially peeled off from the end portion of tape 13 in the circumferential direction by using slit S.

In optical branch cable 1 according to the present embodiment, at least a portion of branch cord portion 20 is housed in branch cord bag 30 wound in a coil shape, making it possible to protect branch cord portion 20 in a state that is easy to take out after manufacturing.

In optical branch cable 1 according to the present embodiment, main surface 31 of branch cord bag 30 has a semicircular shape, making it easy to house in a state of being wound in a coil shape and fitted to branch cord portion 20.

In optical branch cable 1 according to the present embodiment, branch cord bag 30 and main cable 10 are coupled by cable hook or loop fastener portion 18, first hook or loop fastener portion 32a, and second hook or loop fastener portion 32b. Thus, branch cord bag 30 is less likely to be displaced with respect to main cable 10, and thus branch cord portion 20 is less likely to lose its shape from the state of being wound in a coil shape.

In optical branch cable 1 according to the present embodiment, branch cord portion 20 is restricted by bending restriction portion 42 so as not to be bent with a radius less than the predetermined bending radius, and thus it is possible to suppress branch cord portion 20 from being damaged by unintended small-diameter bending.

It is noted that, optical cord group 15 is bundled separately from tension member 12 by first bundle 14. This prevents tension member 12 from being entangled with optical cord 11 during the manufacturing process, the installation work, or the like. If tension member 12 becomes entangled with optical cord 11, tension during installation work may be applied not only to tension member 12 but also to optical cord 11. If the tension is applied to optical cord 11, optical cord 11 may be damaged. In the present embodiment, first bundle 14 prevents tension member 12 from being entangled with optical cord 11, and thus it is possible to prevent optical cord 11 from being damaged during the installation work.

Second bundle 16 bundles optical cord group 15 and tension member 12. This can suppress differences in the relative positional relationship between optical cord group 15 and tension member 12 in the longitudinal direction of main cable 10. In the longitudinal direction of main cable 10, if the relative positional relationship between optical cord group 15 and tension member 12 is spiral, the tension applied to tension member 12 during installation may also be applied to optical cord group 15. In the present embodiment, differences in the relative positional relationship between optical cord group 15 and tension member 12 in the longitudinal direction of main cable 10 can be suppressed, thereby reducing damage to optical cord 11 during installation work.

### Pulling Jig

Next, a pulling jig 201 for pulling optical branch cable 1 will be described. FIG. 9 illustrates the installation of optical branch cable 1 using pulling jig 201. As illustrated in FIG. 9, a plurality of optical branch cables 1 are arranged in parallel in a state of being accommodated in a groove formed in cable laying tray T. Pulling jig 201 is used to pull optical branch cable 1 while maintaining a parallel state of the plurality of optical branch cables 1. It is noted that the plurality of optical branch cables 1 are examples of the optical branch cable set. Further, pulling jig 201 and the optical branch cable set are examples of an optical cable pulling system.

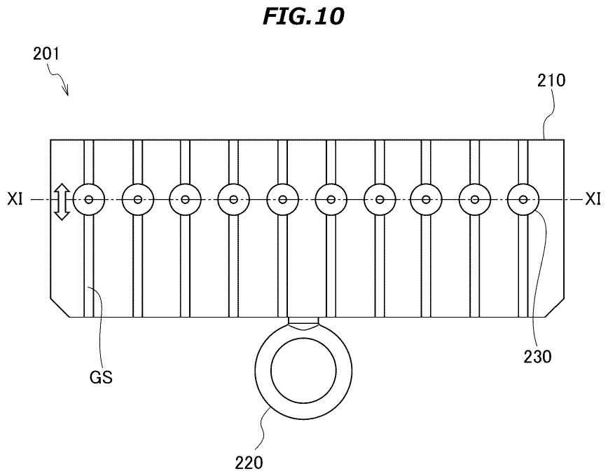

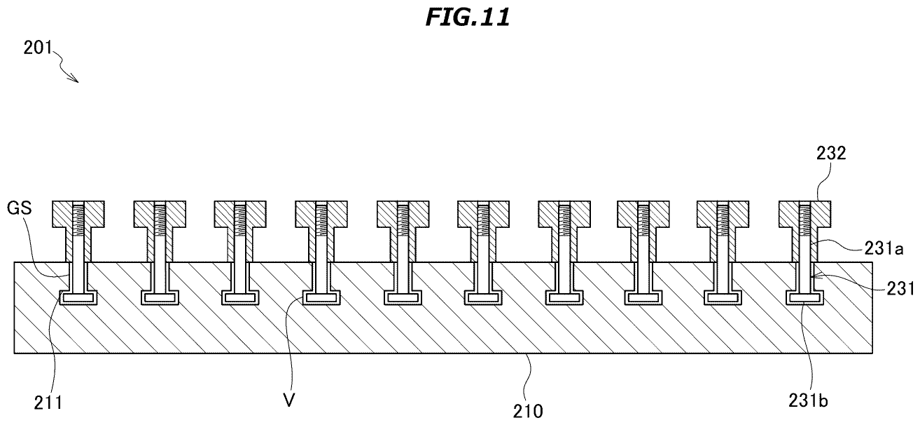

FIG. 10 is a plan view of pulling jig 201. As illustrated in FIG. 10, pulling jig 201 includes a base portion 210, a pulling portion 220, and a plurality of connecting portions 230. Base portion 210 has a width equal to or greater than a parallel state of the plurality of optical branch cables 1. The “width equal to or greater than a parallel state of the plurality of optical branch cables 1” is a width equal to or greater than the total sum of the diameters of the plurality of optical branch cables 1 in a parallel state. Base portion 210 may also have a width slightly less than the width of the groove formed in cable laying tray T, such that the base portion does not rotate in a top view relative to cable laying tray T illustrated in FIG. 9 during pulling.

As illustrated in FIG. 10, guide portions each extending in a direction intersecting the width direction are formed in the width direction (left-right direction on the page) of base portion 210. The number of the guide portions is the same as the number of connecting portions 230. In the present embodiment, the guide portion is formed as a guide slit GS which is a groove formed in base portion 210. Guide slit GS is formed to extend in a direction intersecting the width direction.

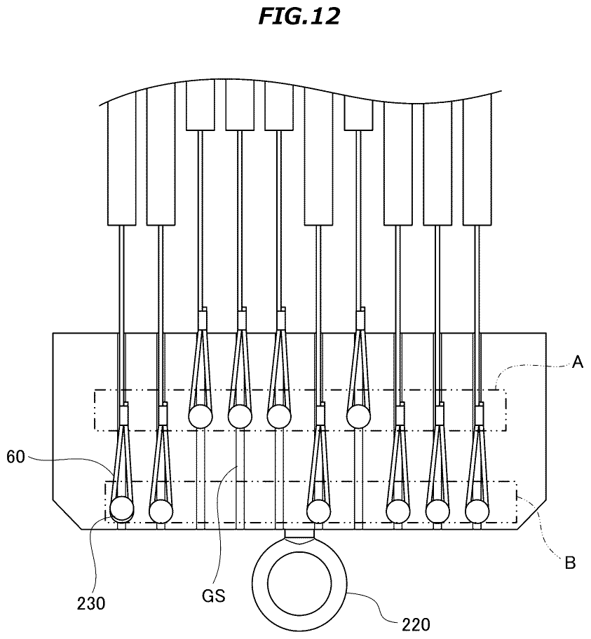

Base portion 210 includes a lower void space V below guide slit GS, and includes an engaged portion 211, which defines an upper surface of void space V communicating with guide slit GS (refer to FIG. 11). Void space V is formed along guide slit GS. Void space Vis formed to be wider than guide slit GS in the width direction.

Pulling portion 220 is provided to enabling a pulling device to be connected. In the present embodiment, pulling portion 220 is formed as a ring-shaped member to be hung on the pulling device.

The plurality of connecting portions 230 are provided at base portion 210 and arranged along the width direction (left-right direction on the page) of base portion 210. Connecting portion 230, by being hung with connecting loop 60, can apply tension in the pulling direction to optical branch cable 1 when pulling jig 201 is pulled.

FIG. 11 is a cross-sectional view of the XI-XI plane in FIG. 10. Connecting portion 230 includes a positioning portion 231 and an engaging tool 232.

Positioning portion 231 includes a shaft portion 231a and an engaging portion 231b. Shaft portion 231a is able to be inserted through guide slit GS, and at least a portion of its outer surface is formed with external thread. Engaging portion 231b is a portion connected to shaft portion 231a. Engaging portion 231b is arranged below guide slit GS. Even when positioning portion 231 is displaced upward, engaging portion 231b abuts against engaged portion 211 and is configured not able to be inserted through guide slit GS.

Engaging tool 232 is provided with internal thread that is able to be fastened with shaft portion 231a. Engaging tool 232 is arranged on the outer surface of base portion 210 and is configured not able to be inserted through guide slit GS.

FIG. 12 illustrates the fixed positions of connecting portions 230. Connecting portion 230 is displaceable along guide slit GS. Each of connecting portions 230 is fixable to any of at least two different positions in a direction intersecting the width direction. In the present embodiment, connecting portion 230 is fixable at a first position A on each guide slit GS or at a second position B closer to pulling portion 220 than first position A. It is note that, first position A and second position B are indicated by dashed line frames in FIG. 12.

Referring back to FIG. 11, connecting portion 230 is fixed by the fastening of engaging tool 232 and shaft portion 231a. By rotating engaging tool 232 in the direction where the fastening between engaging tool 232 and shaft portion 231a is tightened, positioning portion 231 displaces upward, causing engaging portion 231b to come into contact with engaged portion 211. Since engaging tool 232 and shaft portion 231a sandwiches engaged portion 211, connecting portion 230 is fixed to base portion 210 and cannot be displaced on guide slit GS.

The release of connecting portion 230 is performed by loosening the fastening between engaging tool 232 and shaft portion 231a. By rotating engaging tool 232 in the direction where the fastening between engaging tool 232 and shaft portion 231a is loosened, positioning portion 231 displaces below, causing engaging portion 231b to no longer come into contact with engaged portion 211. When the sandwiching of engaged portion 211 by engaging tool 232 and shaft portion 231a is released, connecting portion 230 can be displaced from first position A to second position B or from second position B to first position A.

Accordingly, as illustrated in FIG. 12, connecting portions 230 can be fixed at different positions along guide slit GS in a direction intersecting the width direction. Accordingly, the position at which connecting loop 60, which is the end portion of optical branch cable 1, is connected to pulling jig 201 can be adjusted for each optical branch cable 1.

### Optical Cable Pulling Method

Next, an optical cable pulling method will be described. The pulling of optical branch cable 1 is carried out while maintaining a parallel state in which the plurality of optical branch cables 1 are arranged in parallel in the width direction.

As illustrated in FIG. 12, each of the plurality of connecting portions 230 is connected to one optical branch cable 1. In this state, when pulling jig 201 is pulled, it is easier to apply the same direction and evenly distributed pulling force to all optical branch cables 1 connected to connecting portion 230. Thus, all optical branch cables 1 are easily displaced in the same direction by the same amount, and the plurality of optical branch cables 1 can be pulled together while optical branch cables 1 are aligned.

FIG. 13 illustrates optical branch cable 1 connected to pulling jig 201. FIG. 13 is a view of optical branch cable 1 as viewed of a horizontal direction intersecting the width direction. As illustrated in FIG. 13, fifth hook or loop fastener portion 32e formed in branch cord bag 30 may be coupled to sixth hook or loop fastener portion 32f formed in branch cord bag 30 of adjacent optical branch cable 1. Thus, branch cord bags 30 are coupled to each other, and optical branch cables 1 can be easily maintained in an aligned state during the pulling operation of optical branch cables 1.

When all the optical branch cables are connected to one connecting portion, the optical branch cables are pulled toward one connecting portion. Thus, the direction and magnitude of the pulling force applied to the optical branch cable vary depending on the optical branch cable. In particular, since the optical branch cables arranged at the ends are pulled in the direction toward the center, the optical branch cables may run on or intersect the adjacent optical branch cables. As a result, the parallel state of the optical branch cables may not be maintained.

Pulling jig 201 and the optical cable pulling system according to the present embodiment include the plurality of connecting portions 230 arranged along the width direction. Each of connecting portions 230 is configured to enable one optical branch cable 1 to be connected. Thus, the plurality of optical branch cables 1 can be pulled in a state where each of optical branch cables 1 is connected to connecting portion 230. This enables the plurality of optical branch cables 1 to be pulled together with as equal force as possible, thereby improving the installation workability of optical branch cables 1.

Further, the optical cable pulling method according to the present embodiment includes pulling the plurality of optical branch cables 1 while maintaining a parallel state by using pulling jig 201. By using pulling jig 201, the plurality of optical branch cables 1 can be pulled simultaneously, and thus the installation workability of the optical cables are improved.

Meanwhile, a manufacturing error may occur in a position where a branching portion is formed, where branch cord portion 20 is led out from main cable 10, for each optical branch cable 1. Specifically, the distance from the end portion of optical branch cable 1 to one branching portion may be different between adjacent optical branch cables 1. Further, the distance between the branching portions may be different between adjacent optical branch cables 1. However, even when there is a manufacturing error, the positions of the branching portions need to be aligned to some extent in optical branch cables 1 arranged in parallel.

FIG. 14 illustrates optical branch cable 1 aligned by pulling jig 201. It is noted that, in the illustration of FIG. 14, the positions where branch cord bags 30 are provided indicates the positions of the branching portions in optical branch cable 1. The branch cord bag closest to connecting loop 60 of the illustrated in FIG. 14 is referred to as a first branch cord bag 30A, and the branch cord bag n-th closest to connecting loop 60 is referred to as an n-th branch cord bag.

As illustrated in FIG. 12, connecting portion 230 is fixable at first position or second position different from each other along the cable longitudinal direction in each guide portion. At this time, when connecting portion 230 is connected to optical branch cable 1 having a relatively short distance from connecting loop 60 to first branch cord bag 30A, connecting portion 230 is fixed to first position A. When connecting portion 230 is connected to optical branch cable 1 having a relatively long distance from connecting loop 60 to first branch cord bag 30A, connecting portion 230 is fixed to second position B.

In this way, by ensuring that each connecting portion 230 is positioned at the appropriate first position A or second position B corresponding to each optical branch cable 1, as illustrated in FIG. 14, it is possible to align the positions of first branch cord bags 30A of optical branch cables 1 to some extent.

Further, the distance between branch cord bags 30 may be different depending on optical branch cable 1. Even in such cases, by positioning each connecting portion 230 at first position A or second position B corresponding to optical branch cable 1, as illustrated in FIG. 14, it is possible to align the positions of n-th branch cord bags 30N of optical branch cables 1 to some extent.

As described above, in pulling jig 201 according to the present embodiment, connecting portion 230 is fixable to any one of first position A and second position B which are two different positions in the direction intersecting the width direction. Thus, even when the position of the branching portion is displaced in the direction intersecting the width direction depending on optical branch cable 1, connecting portion 230 can be shifted, and thus the position of the branching portion in the direction intersecting the width direction is easily adjusted to some extent. It is sufficient that each connecting portion 230 is fixable at two different positions in the direction intersecting the width direction, and the fixed positions in the direction intersecting the width direction in each connecting portion 230 may be the same as each other or may be different from each other. That is, a position of a first connecting portion 230 in the direction intersecting the width direction at first position A and a position of a second connecting portion 230 in the direction intersecting the width direction at first position A may be the same as each other or may be different from each other. Similarly, the position of the first connecting portion 230 in the direction intersecting the width direction at second position B and the position of the second connecting portion 230 in the direction intersecting the width direction at second position B may be the same as each other or may be different from each other.

In pulling jig 201 according to the present embodiment, connecting portion 230 is configured to be displaced along the guide portion, and thus a mechanism capable of changing the position of connecting portion 230 in the direction intersecting the width direction can be realized by a simple configuration.

In pulling jig 201 according to the present embodiment, engaging tool 232 is fastened or loosened with respect to shaft portion 231a, and thus it is possible to realize a mechanism for displacing connecting portion 230 with respect to base portion 210 in the direction intersecting the width direction and fixing the position with a simple configuration.

In optical branch cable 1 according to the present embodiment, branch cord bag 30 is provided with fifth hook or loop fastener portion 32e and sixth hook or loop fastener portion 32f, which are outer hook or loop fastener portions. In the optical branch cable set according to the present embodiment, in a state where the optical branch cables are arranged in parallel, branch cord bags 30 of adjacent optical branch cables 1 are coupled to each other by fifth hook or loop fastener portion 32e and sixth hook or loop fastener portion 32f. Thus, when the optical branch cable set is pulled, the plurality of optical branch cables 1 can move integrally. As described above, according to the optical branch cable set of the present embodiment, it is easy to manufacture the optical branch cable set for installing the plurality of optical branch cables 1 in a collective and parallel state.

Even when the positions of first branch cord bags 30A are aligned, the positions of n-th branch cord bags 30N are not necessarily aligned in the width direction (that is, completely adjacent). As illustrated in FIG. 14, the positions of n-th branch cord bags 30N may be shifted in the longitudinal direction of optical branch cables 1. However, in the optical branch cable set according to the present embodiment, fifth hook or loop fastener portion 32e and sixth hook or loop fastener portion 32f extend along the longitudinal direction of main cable 10. Thus, even when the branching portions are shifted in the longitudinal direction of optical branch cable 1, branch cord bags 30 are easily coupled to each other.

### Modification of Optical Branch Cable Set

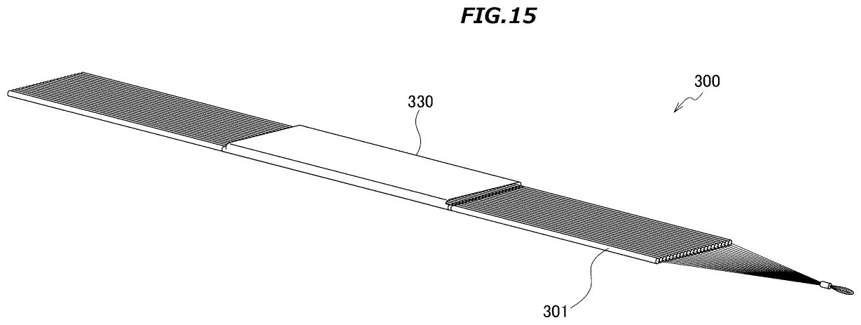

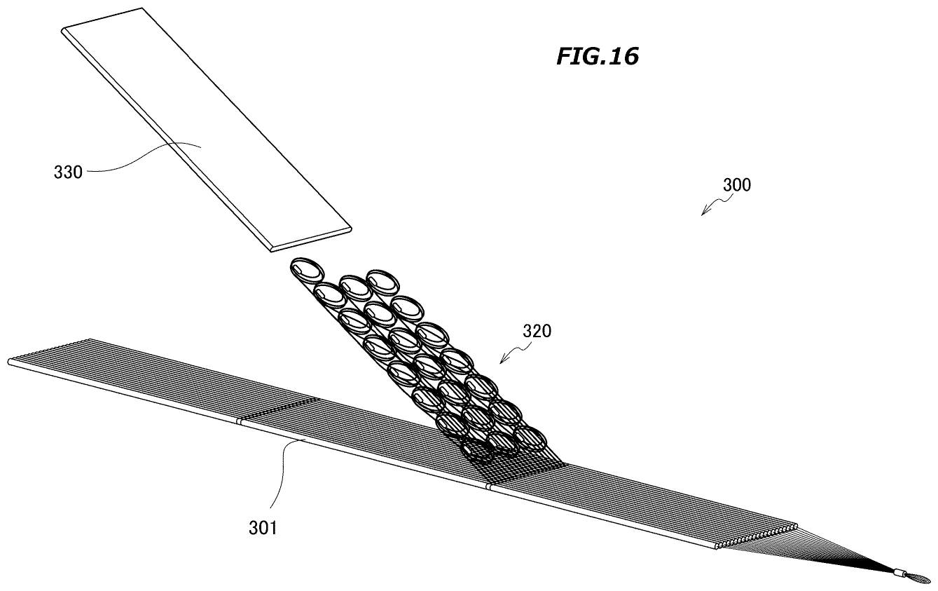

Next, modification of the optical branch cable set will be described. FIG. 15 is a perspective view of an optical branch cable set 300 according to the modification. FIG. 16 illustrates optical branch cable set 300 and a branch cord bag 330 according to the modification.

Optical branch cable set 300 according to the modification includes 22 optical branch cables 301. Optical branch cable 301 according to the modification is different from optical branch cable 1 according to the embodiment shown in FIG. 9 in that the plurality of optical branch cables 301 share one branch cord bag 330. In other words, 22 branch cord portions 320 are accommodated in one branch cord bag 330.

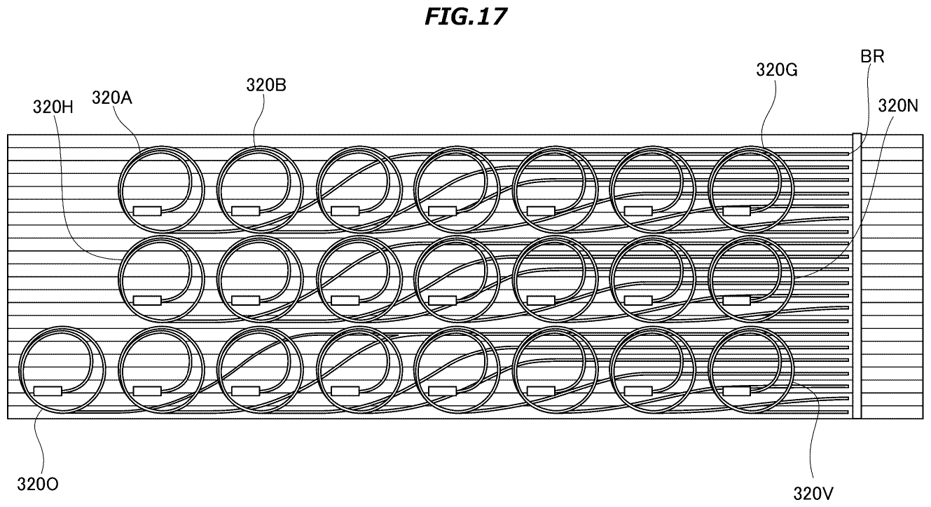

FIG. 17 illustrates an arrangement example of branch cord portion 320 of each optical branch cable 301. For reference, optical branch cables 301 are referred to as a first optical branch cable, a second optical branch cable, . . . , and a twenty-second optical branch cable in the order of arrangement from left to right on the page of FIG. 17. Similarly, branch cord portions 320 of the first optical branch cable, the second optical branch cable, . . . , and the twenty-second optical branch cable are referred to as a first branch cord portion 320A, a second branch cord portion 320B . . . , and a twenty-second branch cord portion 320V, respectively.

As illustrated in FIG. 17, branch cord portions 320 are arranged in three rows in the longitudinal direction of optical branch cable 301. In the upper row, branch cord portions 320 from first branch cord portion 320A to a seventh branch cord portion 320G are arranged. In the center row, branch cord portions 320 from an eighth branch cord portion 320H to a fourteenth branch cord portion 320N are arranged. In the lower row, branch cord portions 320 from a fifteenth branch cord portion 320O to twenty-second branch cord portion 320V are arranged. In plan view, each branch cord portion 320 is wound clockwise in a coil shape.

Branch cord portion 320 may be arranged so that the bending radius is as large as possible. For example, in the upper row, first branch cord portion 320A is arranged at a position farthest from a branching portion BR. The branch cord portions are arranged in order from first branch cord portion 320A to seventh branch cord portion 320G, at positions away from branching portion BR. In other words, seventh branch cord portion 320G is arranged at a position closest to branching portion BR.

Similarly, in the center row, eighth branch cord portion 320H is arranged at a position farthest from branching portion BR. Eighth branch cord portion 320H to fourteenth branch cord portion 320N are arranged in this order at positions away from branching portion BR. In other words, fourteenth branch cord portion 320N is arranged at a position closest to branching portion BR. Further, in the lower row, fifteenth branch cord portion 320O is arranged at a position farthest from branching portion BR. Fifteenth branch cord portion 320O to twenty-second branch cord portion 320V are arranged in this order at positions away from branching portion BR. In other words, twenty-second branch cord portion 320V is arranged at a position closest to branching portion BR.

As branch cord portions 320 are arranged in this way, branch cord portion 320 arranged at the position closest to branching portion BR is branch cord portion 320 of rightmost optical branch cable 301 in each row. At this time, when branch cord portion 320 gets wound clockwise in a coil shape, branch cord portion 320 arranged at the position closest to branching portion BR is less likely to be applied to an excessive small-diameter bending load.

Further, when branch cord portion 320 gets taken out, branch cord portions 320 are arranged in order, and thus, when branch cord portion 320 is connected to server rack 120 or the like, branch cord portions 320 are hardly mistaken, and the connection work of branch cord portion 320 is easy.

In optical branch cable 301 according to the modification, since one branch cord bag 330 accommodates all branch cord portions 320, when optical branch cable set 300 is pulled, the plurality of optical branch cables 301 are easily moved integrally.

Although the present disclosure has been described in detail with reference to the specific embodiments, it will be apparent to those skilled in the art that various changes and modifications can be made without departing from the spirit and scope of the present disclosure. The number, positions, shapes, and the like of the constituent members described above are not limited to those in the above embodiments, and can be changed to the number, positions, shapes, and the like suitable for carrying out the present disclosure.

In the present embodiment, the case of the installation of optical branch cable 1 using pulling jig 201 has been illustrated and explained, but the cable installed using pulling jig 201 is not limited to optical branch cable 1. For example, an optical cable without a branch cord portion may be pulled by using a pulling jig while maintaining a parallel state.

In the present embodiment, connecting portion 230 is fixable at first position A and second position B on guide slit GS, but connecting portion 230 is fixable at three or more points on guide slit GS, and each connecting portion 230 is fixable at, at least two or more different positions on guide slit GS.

What is claimed is:

1. A pulling jig for pulling a plurality of optical cables while maintaining a state in which the optical cables are arranged in parallel, the pulling jig comprising:
a base portion having a width equal to or more than a width in the state in which the plurality of optical cables are arranged in parallel;
a pulling portion for enabling the base portion to be connected to a pulling device; and
a plurality of connecting portions provided at the base portion and arranged in a width direction along the width,
wherein the connecting portions are connectable to the optical cables in at least one-to-one correspondence.

2. The pulling jig according to claim 1,
wherein each of the optical cables includes a main cable including a plurality of optical fiber core wires, and a branch cable portion in which at least one of the optical fiber core wires is led out from the main cable, and
wherein the connecting portions are fixable at any one of at least two different positions in a direction intersecting the width direction.

3. The pulling jig according to claim 2,
wherein a guide portion extending in the direction intersecting the width direction is formed at the base portion, and
wherein each of the connecting portions is displaceable along the guide portion.

4. The pulling jig according to claim 3,
wherein the guide portion is formed as a guide slit,
wherein each of the connecting portions includes a positioning portion and an engaging tool,
wherein the positioning portion includes
a shaft portion being able to be inserted through the guide slit, an external thread being formed on at least a portion of an outer surface, and
an engaging portion disposed below the guide slit, the engaging portion being not able to be inserted through the guide slit,
wherein an internal thread being able to be fastened to the shaft portion is formed in the engaging tool, and
wherein a position of the connecting portion is fixed with respect to the base portion in the direction intersecting the width direction by the engaging tool being fastened to the shaft portion.

5. An optical cable pulling method comprising pulling a plurality of optical cables while maintaining a state in which the optical cables are arranged in parallel using the pulling jig according to claim 1.

6. An optical cable pulling system comprising:
the pulling jig according to claim 1; and
an optical cable set including a plurality of optical cables,
wherein each of the optical cables includes a main cable including a plurality of optical fiber core wires, and a branch cable portion in which at least one of the optical fiber core wires is branched from the main cable,
wherein the plurality of optical cables are arranged in parallel in the width direction, and
wherein the connecting portions are connected to the optical cables in one-to-one correspondence.
